(19) United States
(12) Patent Application Publication
(10) Pub. No.: US 2025/0234908 A1
(43) Pub. Date: Jul. 24, 2025

(54) GRANULAR FOOD, AND METHOD FOR MANUFACTURING SAME

(71) Applicant: SANYO FOODS CO.,LTD., Tokyo (JP)

(72) Inventor: Hiroyuki NAGAOKA, Tokyo (JP)

(73) Assignee: SANYO FOODS CO., LTD., Tokyo (JP)

(21) Appl. No.: 18/853,684

(22) PCT Filed: Mar. 24, 2023
(86) PCT No.: PCT/JP2023/011963

§ 371 Date: Oct. 2, 2024

(30) Foreign Application Priority Data
Apr. 8, 2022 (JP) 2022-064516

(51) Int. Cl. A23L 23/10; A23D 9/013

(52) U.S. Cl. CPC A23L 23/10; A23D 9/013

(57) ABSTRACT

Provided is a granular food which contains oil and fat at a high concentration, and has flowability suitable for being filled in a container in which the occurrence of aggregates of the oil and fat and the seeping out of the oil and fat are suppressed. The granular food comprises: (A) at least one fatty acid ester selected from the group consisting of a (poly)glycerin fatty acid ester having an average degree of polymerization of a glycerin moiety of 1 to 8, and a sucrose fatty acid ester having an HLB of 8 or less; (B) an organic acid salt; (C) oil and fat; and (D) a food raw material, wherein the content of the oil and fat is 3-15 mass % and the Carr index is 79 or higher.

### TECHNICAL FIELD

The present disclosure relates to a granular food and a method for manufacturing the granular food.

### BACKGROUND ART

Various powdery or granular foods have been developed as soups of instant foods such as instant cup noodles and instant cup soup. If stirring is insufficient when hot water or warm water is added to the powdery or granular food, the powdery or granular food is not completely dispersed and an agglomerated mass of the component remains. In order to suppress generation of the agglomerated mass, it has been proposed to add an edible oil and/or fat. By adding the edible oil and/or fat, a surface of the powdery or granular food is made hydrophobic, a repulsive force against hot water or warm water is increased, and generation of an agglomerated mass of the component can be suppressed.

As a granular soup, a powdery soup granulated by granulation is generally used. The powdery soup having a small particle size is likely to be scattered when filled in a container for an instant food. The scattered powdery soup may adhere to an inner wall of the container due to static electricity or moisture, or it may cause difficulty in controlling the filling amount in a filling step. These issues are less likely to occur in the case of granular soup. Known examples of a method of processing the powdery soup into granular form include extrusion granulation and fluidized bed granulation.

By increasing an amount of the liquid or semi-solid oil and/or fat, the flavor and taste of the instant food can be enhanced. As a means for increasing the amount of oil and/or fat, a powder oil and/or fat produced by emulsifying a liquid oil and/or fat and drying by spray drying or the like is generally known. Since the liquid oil and/or fat in the powder oil and/or fat is emulsified, oil droplets are less likely to generate on a soup surface, even when hot water is added to the instant food. Thus, the appearance of an instant food using the powder oil and/or fat at the time of eating is different from those of ramen, soup, and the like provided in a restaurant.

In a soup having a curry flavor in an instant food, and the like, there is known a granular soup containing oil and/or fat such as lard at a high concentration by extrusion granulation. However, since extrusion granulation includes a high-temperature step, the fragrance of seasoning oil is likely to be lost. When oil and/or fat such as lard is contained at a high concentration by extrusion granulation, it is not possible to completely suppress oozing of the oil and/or fat from the granular soup. If the amount of an excipient is increased in order to prevent the oil and/or fat from oozing, the production cost of the granular soup increases.

It is generally known to attach individually packaged liquid or semi-solid seasoning oil to an instant food in order to bring the appearance of the instant food at the time of eating closer to a food product provided in a restaurant and maintain the fragrance of the seasoning oil. The individually packaged seasoning oil is glued to a lid of the container of the instant food, or is shipped as a product in a state of being enclosed inside the container, and is added to the instant food at the time of eating. However, individual packaging of the seasoning oil requires additional packaging materials and work steps, thus increasing the production cost of the instant food. Therefore, a granular soup containing oil and/or fat at a high concentration is desired.

PTL 1 (JP 2015-019589 A) describes “a powdery or granular seasoning composition containing from 5 to 30 wt. % of oil and/or fat, a base material for containing oil and/or fat, and a polyol”.

PTL 2 (JP 2004-035700 A) describes “a powdery or granular oil and/or fat containing oil and/or fat, a base material for containing oil and/or fat, and a polyol, and having a moisture content of 15 wt. % or less, a maximum particle size of 10 mm or less, an average particle size of 5 mm or less, and an angle of repose of 700 or less”.

PTL 3 (JP S64-027430 A) describes “a powdery or granular oil and/or fat which is an oil and/or fat containing composition containing oil and/or fat, a base material for containing oil and/or fat, and a polyol, in which the composition has a moisture content of 15 wt. % or less, a particle size of 10 mm or less at the maximum, an average particle size of 5 mm or less, and an angle of repose of 70° or less”.

PTL 4 (JP 2005-021016 A) describes, as a “water-soluble powdery or granular food which hardly causes ‘a lump (agglomerate)’ when dispersed or dissolved in water, warm water or hot water”, a “powdery or granular food containing triglycerin behenate”.

PTL 5 (JP 2003-304826 A) describes “granular or powdery instant soup or instant sauce containing polyglycerin behenate in a proportion of from 0.1 to 0.9 mass %” as “granular or powdery instant soup or instant sauce with improved dispersibility and suppressed the ‘lump (agglomerate)’”.

### CITATION LIST

### Patent Literature

PTL 1: JP 2015-019589 A
PTL 2: JP 2004-035700 A
PTL 3: JP S64-027430 A
PTL 4: JP 2005-021016 A
PTL 5: JP 2003-304826 A

### SUMMARY OF INVENTION

### Technical Problem

In a method for suppressing generation of an agglomerated mass of a soup component by adding the edible oil and/or fat to the granular soup, when the amount of the edible oil and/or fat added is increased, an aggregate containing the edible oil and/or fat is generated in a step of mixing the soup component or a step of granulating into the granular soup, the production yield is reduced, the edible oil and/or fat oozes out from the powdery or granular soup produced, and the fluidity of the powdery or granular soup is reduced. Thus, this method has limitations from the viewpoint of the production step, cost, and product quality.

When the concentration of the oil and/or fat contained in the granular soup increases, the oil and/or fat oozes out on a surface of the granular soup, and the fluidity of the granular soup as a powder decreases. The granular soup with low fluidity may interfere with a filling step due to formation of a bridge at a discharge port of a hopper or adhesion to an inner wall of the hopper, and it is also difficult to control the filling amount.

The present disclosure provides a granular food having fluidity suitable for filling a container, the granular food containing oil and/or fat at a high concentration and having suppressed generation of an aggregate of the oil and/or fat and oozing out of the oil and/or fat.

### Solution to Problem

The present inventor has found that by combining a specific fatty acid ester and an organic acid salt, it is possible to suppress generation of an aggregate of an edible oil and/or fat and oozing out of the edible oil and/or fat to enhance fluidity of a granular food even when the oil and/or fat is contained at a high concentration, thereby completing the present invention.

The present invention includes the following aspects 1 to 5.

### [Aspect 1]

A granular food including:
(A) at least one fatty acid ester selected from the group consisting of a (poly)glycerin fatty acid ester having an average polymerization degree of a glycerin moiety of from 1 to 8 and a sucrose fatty acid ester having an HLB of 8 or less;
(B) an organic acid salt;
(C) an oil and/or fat; and
(D) a food raw material,
in which
the granular food contains from 3 mass % to 15 mass % of the oil and/or fat, and has a Carr index of 79 or greater.

### [Aspect 2]

The granular food according to Aspect 1, in which the organic acid salt includes at least one selected from the group consisting of sodium lactate and potassium lactate.

### [Aspect 3]

A granular food including:
(A) at least one fatty acid ester selected from the group consisting of a (poly)glycerin fatty acid ester having an average polymerization degree of a glycerin moiety of from 1 to 8 and a sucrose fatty acid ester having an HLB of 8 or less;
(B) an organic acid salt;
(C) an oil and/or fat; and
(D) a food raw material,
in which
the granular food contains greater than 15 mass % and 20 mass % or less of the oil and/or fat, and has a Carr index of 67 or greater.

### [Aspect 4]

The granular food according to Aspect 3, in which the organic acid salt includes at least one selected from the group consisting of sodium lactate and potassium lactate.

### [Aspect 5]

A method for manufacturing a granular food, the method including:
preparing a first mixture of (A) at least one fatty acid ester selected from the group consisting of a (poly)glycerin fatty acid ester having an average polymerization degree of a glycerin moiety of from 1 to 8 and a sucrose fatty acid ester having an HLB of 8 or less and (D) a food raw material;
preparing a second mixture of an organic acid salt dispersion oil including (B) an organic acid salt and (C) an oil and/or fat, and the first mixture; and
forming a granulated product of the second mixture by fluidized bed granulation.

### Advantageous Effects of Invention

According to the present invention, there is provided a granular food having fluidity suitable for filling in a container, the granular food containing oil and/or fat at a high concentration and having suppressed generation of an aggregate of the oil and/or fat and oozing out of the oil and/or fat, and a method for manufacturing the granular food.

The above descriptions shall not be interpreted as disclosure of all of the embodiments of the present invention or all of the advantages of the present invention.

### DESCRIPTION OF EMBODIMENTS

Hereinafter, the present invention will be described in detail to describe representative embodiments. However, the present invention is not limited to these embodiments.

### <Granular Food>

A granular food according to one embodiment contains (A) at least one fatty acid ester selected from the group consisting of a (poly)glycerin fatty acid ester having an average polymerization degree of a glycerin moiety of from 1 to 8 and a sucrose fatty acid ester having an HLB of 8 or less, (B) an organic acid salt, (C) an oil and/or fat, and (D) a food raw material. The granular food contains from 3 mass % to 15 mass % of the oil and/or fat of the granular food, and has a Carr index of 79 or greater.

A granular food according to another embodiment contains (A) at least one fatty acid ester selected from the group consisting of a (poly)glycerin fatty acid ester having an average polymerization degree of a glycerin moiety of from 1 to 8 and a sucrose fatty acid ester having an HLB of 8 or less, (B) an organic acid salt, (C) an oil and/or fat, and (D) a food raw material. The granular food contains greater than 15 mass % and 20 mass % or less of the oil and/or fat of the granular food, and has a Carr index of 67 or greater.

### (A) Fatty Acid Ester

A fatty acid ester is at least one selected from the group consisting of a (poly)glycerin fatty acid ester having an average polymerization degree of a glycerin moiety of from 1 to 8 and a sucrose fatty acid ester having an HLB of 8 or less. Without being bound by any theory, it is construed that the fatty acid ester forms a network structure in the coexistence of a liquid or semi-solid oil and/or fat, and incorporates the liquid or semi-solid oil and/or fat into the network structure to form a gel or a solid. It can also be said that the oil and/or fat is roughly emulsified in the gel or the solid. As a result, it is possible to impart high fluidity to the granular food by suppressing the formation of an aggregate containing the oil and/or fat and the oozing out of the oil and/or fat while increasing the content of the oil and/or fat of the granular food. The network structure can incorporate not only the oil and/or fat, but also components such as spices. Thus, during a fluidized bed granulation step performed at, for example, a temperature of from 60° C. to 80° C., volatilization of the above components can be suppressed while the fluidity of a granulated product is maintained, whereby the flavor of the granular soup can be enhanced. In addition, the network structure of the fatty acid ester is disintegrated in hot water at, for example, from 90° C. to 100° C. to release a relatively large mass of oil and/or fat that is roughly emulsified to the outside. This makes it possible to form oil droplets of oil and/or fat when hot water is added to the granular food.

The melting point of the fatty acid ester is preferably 50° C. or greater, more preferably 60° C. or greater, and still more preferably 70° C. or greater. When the melting point of the fatty acid ester is 50° C. or greater, moisture resistance can be imparted to the granular food while melting of the fatty acid ester is avoided. The melting point of the fatty acid ester is preferably 100° C. or less, more preferably 90° C. or less, and still more preferably 80° C. or less. When the melting point of the fatty acid ester is 100° C. or less, cleaning and the like in piping of a maintenance production facility can be easily performed.

### <<(Poly)Glycerin Fatty Acid Ester>>

The (poly)glycerin fatty acid ester is an ester of a fatty acid and glycerin or a condensate of glycerin (polyglycerin). The average polymerization degree of the glycerin moiety is from 1 to 8. The (poly)glycerin fatty acid ester may be completely esterified or may be partially esterified. The fatty acid moiety of the (poly)glycerin fatty acid ester may be a saturated fatty acid or an unsaturated fatty acid. The fatty acid moiety of the (poly)glycerin fatty acid ester is preferably a saturated fatty acid.

The HLB of the (poly)glycerin fatty acid ester is preferably 8 or less, more preferably 6 or less, and still more preferably 4 or less. A granular food containing a (poly)glycerin fatty acid ester having a large number of lipophilic groups has high moisture resistance. From this viewpoint, the HLB of the fatty acid ester can be 1 or greater, or 3 or greater. In the present disclosure, the HLB is a value calculated from Griffin's empirical formula.

$$HLB = 20 \times ( 1 - SV / NV )$$

SV: Saponification value of (poly)glycerin fatty acid ester or sucrose fatty acid ester
NV: Neutralization value of fatty acid

The number of carbon atoms in the fatty acid moiety of the (poly)glycerin fatty acid ester is preferably from 16 to 22. Examples of the (poly)glycerin fatty acid ester include monoglycerin fatty acid esters such as monoglycerin palmitate, monoglycerin stearate, monoglycerin eicosanoate, and monoglycerin behenate; diglycerin fatty acid esters such as diglycerin palmitate, diglycerin stearate, diglycerin eicosanoate, and diglycerin behenate; triglycerin fatty acid esters such as triglycerin palmitate, triglycerin stearate, triglycerin eicosanoate, and triglycerin behenate; tetraglycerin fatty acid esters such as tetraglycerin palmitate, tetraglycerin stearate, tetraglycerin eicosanoate, and tetraglycerin behenate; pentaglycerin fatty acid esters such as pentaglycerin palmitate, pentaglycerin stearate, pentaglycerin eicosanoate, and pentaglycerin behenate; hexaglycerin fatty acid esters such as hexaglycerin palmitate, hexaglycerin stearate, hexaglycerin eicosanoate, and hexaglycerin behenate; heptaglycerin fatty acid esters such as heptaglycerin palmitate, heptaglycerin stearate, heptaglycerin eicosanoate, and heptaglycerin behenate; octaglycerin fatty acid esters such as octaglycerin palmitate, octaglycerin stearate, octaglycerin eicosanoate, and octaglycerin behenate; and a mixture of two or more thereof. The (poly)glycerin fatty acid ester more preferably includes a (poly)glycerin stearate in which the fatty acid moiety is stearic acid (having 18 carbon atoms).

The (poly)glycerin fatty acid ester preferably contains a mixture of a monoglycerin fatty acid ester and a polyglycerin fatty acid ester, more preferably contains a mixture of a monoglycerin behenate and an octaglycerin stearate; a mixture of monoglycerin stearate, pentaglycerin palmitate, and pentaglycerin stearate; or a mixture of monoglycerin stearate and diglycerin stearate, and particularly preferably contains a mixture of monoglycerin behenate and octaglycerin stearate. The mixture of the monoglycerin fatty acid ester and the polyglycerin fatty acid ester can improve the fluidity of the granular food, promote the formation of oil droplets at the time of eating, and retain the flavor by encompassing the oil and/or fat and a spice extract (spice).

### <<Sucrose Fatty Acid Ester>>

A sucrose fatty acid ester is an ester of a fatty acid and sucrose. The sucrose fatty acid ester has an HLB of 8 or less. The sucrose fatty acid ester may be completely esterified or partially esterified. The fatty acid moiety of the sucrose fatty acid ester may be a saturated fatty acid or an unsaturated fatty acid. The fatty acid moiety of the sucrose fatty acid ester is preferably a saturated fatty acid.

The HLB of the sucrose fatty acid ester is preferably 6 or less, more preferably 4 or less. A granular food containing a sucrose fatty acid ester having a large number of lipophilic groups and a small number of hydrophilic groups has high moisture resistance. From this viewpoint, the HLB of the sucrose fatty acid ester may be 1 or greater, or 3 or greater.

The number of carbon atoms in the fatty acid moiety of the sucrose fatty acid ester is preferably 16 to 22. Examples of the sucrose fatty acid ester include sucrose palmitate, sucrose stearate, sucrose eicosanoate, and sucrose behenate. The sucrose fatty acid ester more preferably contains at least one selected from the group consisting of sucrose palmitate in which the fatty acid moiety is palmitic acid (having 16 carbon atoms) and sucrose stearate in which the fatty acid moiety is stearic acid (having 18 carbon atoms).

### (B) Organic Acid Salt

The organic acid salt is not particularly limited as long as it is used for food applications. Without being bound by any theory, by adding an organic acid salt to a food raw material, it is possible to suppress the occurrence of aggregation of the oil and/or fat during the production of a granular food, to disperse the oil and/or fat more uniformly in the granular food, and to semi-solidify or solidify the oil and/or fat to retain the oil and/or fat in the granular food. As a result, it is possible to suppress the oozing out of the oil and/or fat from the granular food, to suppress the aggregation of the granular food even when the granular food is stored for a long period of time, and to maintain the fluidity.

The number of carbon atoms of the organic acid salt is preferably 2 to 16, and more preferably 3 to 10.

The organic acid salt preferably further has a polar group selected from the group consisting of a hydroxy group and an amino group.

The cation of the organic acid salt is preferably at least one selected from the group consisting of a sodium cation and a potassium cation.

Examples of the organic acid salt include sodium lactate, potassium lactate, calcium lactate, and sodium pyrrolidonecarboxylate. The organic acid salt preferably contains at least one selected from the group consisting of sodium lactate and potassium lactate, and is more preferably at least one selected from the group consisting of sodium lactate and potassium lactate.

(C) Oil and/or Fat

The oil and/or fat is not particularly limited, and vegetable oils, animal oil and/or fat, processed oil and/or fat, or a combination of two or more thereof can be used. Examples of the vegetable oil include soybean oil, rapeseed oil, palm oil, coconut oil, corn oil, cottonseed oil, sesame oil, rice oil, olive oil, safflower oil, peanut oil, grape seed oil, perilla oil, linseed oil, camellia oil, evening primrose oil, herb oil, and Chinese chili oil. Examples of the animal oil and/or fat include pig fat (lard), beef tallow (tallow), chicken fat, and fish oil. Examples of the processed oil and/or fat include margarine, shortening, medium chain fatty acid-containing oil, monoglyceride, and diglyceride.

The melting point of the oil and/or fat can be, for example, from 0° C. to 50° C. In one embodiment, the oil and/or fat is liquid at room temperature (23° C.).

### (D) Food Raw Material

The food raw material is a main component that determines the flavor and taste of the granular food, and is generally a mixture containing a crystalline product and a powder raw material.

Examples of the crystalline product include salts, granulated sugars, sodium glutamate, sodium inosinate, disodium succinate, glucose, and ribonucleotide disodium. The crystalline product is preferably micronized.

The powder raw material generally contains a flavor component. The flavor component is an element that imparts a taste (sense of taste) or a scent (sense of smell) to food. Examples of the flavor component include common seasonings such as salt and sugar; fermentation-related seasoning such as soy sauce, vinegar, mirin, and miso; spice-based seasonings such as garlic, ginger, pepper, laurel, thyme, and seige; extracts such as meat extract (beef, pork, chicken, etc.), fish and shellfish extract, vegetable extract, boiling concentrate of animal and plant tissue, yeast extract, and fermented extract; acidulants such as citric acid, malic acid, acetic acid, and lactic acid; and seasonings such as an amino acid, a nucleic acid, an organic acid other than an acidulant, an inorganic salt, a protein hydrolysate, and a nucleic acid hydrolysate. The powder raw material may further contain a spice, a fragrance, a stabilizer (sodium caseinate, xanthan gum, etc.), an emulsifier, an excipient, or an antioxidant, or a combination of two or more thereof.

### <<Carr Index>>

The Carr index is defined as a sum obtained by indexing information (loose bulk density, solid bulk density, compressibility, angle of repose, angle of disintegration, and angle of difference) obtained from a powder characteristic evaluation apparatus with reference to a fluidity index table and a floodability index table, and then adding a fluidity index to these indices. In other words, Carr index=compressibility index+angle of repose index+fluidity index+angle of disintegration index+angle of difference index (see also Tohei YOKOYAMA et al., “Experimental Production of Apparatus for Measuring fluidity of Powders by Carr's Method”, Journal of the Society of Powder Technology, Japan, Vol. 6, No. 4 (1969), pp. 264 to 291).

In an embodiment in which the content of the oil and/or fat in the granular food is from 3 mass % to 15 mass %, high fluidity suitable for filling a container can be imparted to the granular food by controlling the Carr index of the granular food to 79 or greater. In this embodiment, the Carr index of the granular food is preferably 80 or greater, and more preferably 81 or greater.

In an embodiment in which the content of the oil and/or fat in the granular food is greater than 15 mass % and 20 mass % or less, by controlling the Carr index of the granular food to 67 or greater, it is possible to provide to a high oil and/or fat granular food having fluidity suitable for filling a container. In this embodiment, the Carr index of the granular food is preferably 68 or greater.

### <<Compressibility>>

The compressibility of the granular food is preferably 18% or less, more preferably 15% or less, still more preferably 12% or less, and particularly preferably 10% or less. By controlling the compressibility to 18% or less, a filling amount of the granular food can be precisely controlled. The compressibility is determined at room temperature (23° C.) according to the following procedure using a powder characteristic evaluation apparatus. An outlet (outlet inner diameter: 7 mm) of a funnel is corresponded to a height of 38 cm from an upper surface of a cylindrical container having an inner diameter of 40 mm, a height of 80 mm, and a volume of 100 cm³. When a granular food having an amount of about 120 cm³ is put in the funnel and dropped, the mass of the granular food filled in the cylindrical container is defined as a loose bulk density a (g/100 cm³). When a cap for replenishing is attached to the same cylindrical container, the granular food is dropped in the same procedure as in the measurement of the loose bulk density a, the granular food is densified by tapping 10 times, then the cap is removed, and thereafter the excess granular food protruding from the upper surface of the cylindrical container is scraped, the mass of the granular food which has been filled in the cylindrical container is defined as a solid bulk density b (g/100 cm³). A value obtained by the formula: (b−a)×100/b is defined as the compressibility.

### <<Angle of Repose, Angle of Disintegration, and Angle of Difference>>

The angle of repose and the angle of disintegration are determined at room temperature (23° C.) according to the following procedure using a powder characteristic evaluation apparatus. The granular food is dropped on a disk having a diameter of 8 cm through a funnel having an outlet height of 12 cm and an outlet inner diameter of 7 mm, and an angle of a skirt of a mountain formed by the granular food is defined as the angle of repose, and an angle of the skirt after impact is applied to the mountain three times is defined as the angle of disintegration. The angle of difference is the difference between the angle of repose and the angle of disintegration (angle of repose−angle of disintegration).

An average particle size D₅₀ of the granular food can be, for example, from 30 μm to 1600 μm, from 40 μm to 1500 μm, or from 50 μm to 1400 μm. In the present disclosure, the average particle size D₅₀ of the powder or granules is a cumulative volume median diameter determined using a laser diffraction scattering method.

The content of the fatty acid ester in the granular food is preferably from 0.2 mass % to 1.6 mass %, more preferably from 0.4 mass % to 1.4 mass %, and still more preferably from 0.6 mass % to 1.2 mass %.

The content of the organic acid salt in the granular food is preferably from 0.2 mass % to 8 mass %, more preferably from 0.3 mass % to 5 mass %, and still more preferably from 0.4 mass % to 3 mass %.

In one embodiment, the content of the oil and/or fat in the granular food is from 3 mass % to 15 mass %, preferably from 5 mass % to 15 mass %, and more preferably from 10 mass % to 15 mass %. In another embodiment, the content of the oil and/or fat in the granular food is greater than 15 mass % and 20 mass % or less, and preferably from 15.5 mass % to 20 mass %. The content of the oil and/or fat varies depending on the types of the food raw material, fatty acid ester, and oil and/or fat, and can be appropriately set according to a product specification of the granular food and the required fluidity (Carr index).

When the granular food contains an additive selected from the group consisting of an extract and a paste seasoning, the content of the additive in the granular food is preferably 0.7 times or less, more preferably 0.5 times or less, and still more preferably 0.3 times or less the content of the oil and/or fat in the granular food on a mass basis.

The content of the food raw material in the granular food is generally from 70 mass % to 96 mass %, preferably from 75 mass % to 96 mass %, and more preferably from 78 mass % to 96 mass % with respect to the solid content of the food raw material. When the granular food contains an additive selected from the group consisting of an extract and a paste seasoning, the content of the food raw material of the granular food is preferably from 55 mass % to 95 mass %, more preferably from 60 mass % to 95 mass %, and still more preferably from 65 mass % to 95 mass % with respect to the solid content of the food raw material.

In the granular food, the content of a dextrin compound is preferably 10 mass % or less, more preferably 5 mass % or less, and still more preferably 1 mass % or less. By setting the content of the dextrin compound within the above range, it is possible to retain a delicate flavor and scent that may be impaired by an artificial odor of the dextrin compound.

In the granular food, a total content of starch and processed starch is preferably 35 mass % or less, more preferably 25 mass % or less, and still more preferably 20 mass % or less. When the total content of the starch and the processed starch that contribute to the mouth-feel and food texture other than the taste is within the above range, a taste component in the food raw material can be more effectively perceived, and the flavor and taste of the granular food can be enhanced.

### <Method for Manufacturing Granular Food>

A method for manufacturing a granular food according to one embodiment includes: preparing a first mixture of (A) at least one fatty acid ester selected from the group consisting of a (poly)glycerin fatty acid ester having an average polymerization degree of a glycerin moiety of from 1 to 8 and a sucrose fatty acid ester having an HLB of 8 or less and (D) a food raw material; preparing a second mixture of an organic acid salt dispersion oil containing (B) an organic acid salt and (C) an oil and/or fat and the first mixture; and forming a granulated product of the second mixture by fluidized bed granulation.

### <<Preparation of First Mixture>>

The first mixture can be prepared by mixing the fatty acid ester and the food raw material using a mixing device such as a conical blender, a Nauter, or a ribbon mixer. The components of the food raw material may be premixed using a mixing device such as a conical blender, a Nauter, or a ribbon mixer to prepare a premix, and then the premix and the fatty acid ester may be mixed.

### <<Preparation of Organic Acid Salt Dispersion Oil>>

The organic acid salt dispersion oil containing an organic acid salt and an oil and/or fat can be prepared using an ordinary stirrer or homogenizer. For example, when a tank (product number: SPTL, available from Shiro Sangyou Co., Ltd.) having an inner diameter of 476 mm is used as an actual machine scale, a stirring blade (diameter: 125 mm) of a tornado stirrer (product name: TORNADO, turbine type T-125, stirring shaft: 50 cm, available from AS ONE Corporation) is disposed at a center of the tank so that a gap from a tank inner wall to a tip of the stirring blade is 170 mm and a height from a tank bottom surface is from 5 to 10 mm, and stirring is performed. When a 3 L glass beaker with an inner diameter of 165 mm (available from AGC Techno Glass Co., Ltd.) is used as a pilot scale, a stirring blade (diameter: 65 mm) of a tornado stirrer (product name: TORNADO, propeller type P-65, stirring shaft: 50 cm, available from AS ONE Corporation) is disposed at a center of the beaker so that a gap from an inner wall of the beaker to the tip of the stirring blade is 50 mm and a height from a bottom surface of the beaker is from 2 to 5 mm, and stirring is performed.

The organic acid salt is preferably used in the preparation of the organic acid salt dispersion oil in the form of an aqueous solution. By using an organic acid salt aqueous solution, it is possible to prepare an organic acid salt dispersion oil in which an organic acid salt is more uniformly dispersed and which is difficult to separate into two layers over time. The concentration of the organic acid salt in the organic acid salt aqueous solution can be, for example, from 10 mass % to 90 mass %, and is preferably from 20 mass % to 80 mass %. A two-layer system of the organic acid salt aqueous solution and the oil and/or fat becomes a uniform dispersion system by, for example, stirring at a rotation speed of from 400 to 450 rpm for a stirring time of 10 to 20 minutes.

The content of the organic acid salt in the organic acid salt dispersion oil is preferably from 2 to 20 mass %, more preferably from 4 to 18 mass %, and still more preferably from 5 to 15 mass %.

The organic acid salt dispersion oil may contain at least one additive selected from the group consisting of an extract and a paste seasoning. The extract or paste seasoning imparts taste, scent, flavor, and the like to the granular food. The organic acid salt dispersion oil containing the extract or the paste seasoning can maintain a dispersion state of the organic acid salt for a longer period of time as compared with the organic acid salt dispersion oil not containing the extract or the paste seasoning. In this embodiment, the extract and the paste seasoning contained in the organic acid salt dispersion oil can be effectively incorporated into the granular food together with the oil and/or fat. Examples of the extract include sauces such as soy sauce and fish sauce, meat extracts such as pork extract, beef extract, and chicken extract, fish extracts, and vegetable extracts. Examples of the paste seasoning include miso, sesame paste, and curry roux.

In one embodiment, the content of the additive in the organic acid salt dispersion oil is 2 times or less, preferably equal to or less, and more preferably 0.5 times or less the content of the oil and/or fat in the organic acid salt dispersion oil on a mass basis.

When the organic acid salt dispersion oil further contains at least one additive selected from the group consisting of an extract and a paste seasoning, the content of the organic acid salt in the organic acid salt dispersion oil is preferably 0.5 mass % to 15 mass %, more preferably 1 mass % to 13 mass %, and still more preferably 2 mass % to 10 mass %.

When the organic acid salt dispersion oil further contains at least one additive selected from the group consisting of an extract and a paste seasoning, the content of the organic acid salt in the organic acid salt dispersion oil is preferably 0.7 times or less, more preferably 0.5 times or less, and still more preferably 0.3 times or less the content of the oil and/or fat in the organic acid salt dispersion oil on a mass basis.

### <<Preparation of Second Mixture>>

Next, the organic acid salt dispersion oil and the first mixture are mixed to prepare a second mixture. The second mixture can be used as a powdery soup as it is or after drying. For example, the organic acid salt dispersion oil can be put into a container provided with a hole having a diameter of from 1.0 to 4.0 mm at the bottom and added dropwise to the first mixture from the container. The organic acid salt dispersion oil and the first mixture can be mixed using a mixing device such as a conical blender, a Nauter, a ribbon mixer, or a pin-type mixer. The mixing of the organic acid salt dispersion oil and the first mixture can also be performed using a rotatable storage container, for example, a rotatable tote-bin. The mixing device is preferably a conical ribbon mixer or a pin-type mixer, and more preferably the pin-type mixer, since the organic acid salt dispersion oil and the first mixture can be more uniformly mixed.

The organic acid salt dispersion oil is preferably mixed with the first mixture immediately after preparation. A mixing time is preferably within 20 minutes, and more preferably within 10 minutes.

The second mixture may be sized using a vibration sieve of from 8 to 10 mesh (opening size: 0.9 mmφ to 2.25 mmφ). The sized second mixture may be used as it is in a step of forming a granulated product or may be temporarily stored in a storage container such as a flexible container bag.

### <<Formation of Granulated Product>>

In this embodiment, a granulated product is formed from the second mixture using fluidized bed granulation. In the fluidized bed granulation, the second mixture can be uniformly suspended in the fluidized bed without forming an agglomerated mass of the second mixture, so that a granular food having stable quality can be economically formed.

In the fluidized bed granulation, while the second mixture in a powder state is suspended, a binder for aggregating the powder by liquid crosslinking may be sprayed to the second mixture. Examples of the spraying method include top spray, bottom spray, and tangential spray. Examples of the binder include water, thickening polysaccharides (guar gum, locust bean gum, xanthan gum, and the like), starch, corn syrup, carboxymethyl cellulose (CMC), and gelatin. The thickening polysaccharides, starch, corn syrup, CMC, and gelatin are generally sprayed in the form of an aqueous solution. The binder concentration in the binder aqueous solution is preferably from 0.3 mass % to 0.7 mass %. By liquid-crosslinking the powder with the binder, the compressibility of the granulated product can be increased. When the compressibility of the granulated product is increased, weight errors in automatic cup filling using a stroke feeder device can be reduced. An amount of the binder used can be generally from 0.04 parts by mass to 0.05 parts by mass in a pilot scale and from 0.08 parts by mass to 0.1 parts by mass in an actual machine scale with respect to 100 parts by mass of the total of the fatty acid ester and the food raw material. The binder is preferably sprayed at 55° C. or greater, and more preferably sprayed at from 60° C. to 65° C. By setting the spray temperature to 55° C. or greater, the network formation of the fatty acid ester can be promoted, and the oil and/or fat can be efficiently absorbed into the granular food. By setting the spray temperature to 65° C. or less, volatilization of flavor in the oil and/or fat can be suppressed, thereby to obtain a granular food having excellent flavor.

When the granular food obtained after granulation is allowed to stand and cooled, the network formation of the fatty acid ester and semi-solidification or solidification of the oil and/or fat by organic acid salt can be promoted. After the granular food is allowed to stand and cooled, food having a large particle size may be removed using a vibrating sieve or the like.

The average particle size D₅₀ of the granulated product can be, for example, from 30 μm to 1600 μm, from 40 μm to 1500 μm, or from 50 μm to 1400 μm. By setting the average particle size D₅₀ of the granulated product to from 30 μm to 1600 μm, the compressibility of the granular food can be further reduced.

The compressibility of the granulated product is preferably 18% or less, more preferably 15% or less, and still more preferably 12% or less. By setting the compressibility of the granulated product to 18% or less, the compressibility of the granular food can be further reduced. By heating the granulated product to reduce a water content, a target compressibility can also be obtained.

### <Method of Using Granular Food>

The granular food can be used in a variety of applications. Examples of the use of the granular food include granular soup, dried seasoning powders, and seasoning of other food products (for example, snacks, french fries, and the like). The granular food can be particularly suitably used as granular soup.

### EXAMPLES

In the following examples, specific embodiments of the present disclosure are illustrated, but the present invention is not limited thereto. All parts and percentages, including the tables, are by weight unless otherwise indicated.

### <Raw Materials>

The raw materials used in this example are shown in Table 1.

TABLE 1

| Abbreviation | Description | Component | Product name | Supply source |
|---|---|---|---|---|
| Ap-1 | Fatty acid ester | Mixture of monoglycerin behenate and | — | — |
| | | octaglycerin stearate | | |
| Pol-1 | Polyol | Glycerin (>99%) | Food additive glycerin | Kao Corporation |
| Pol-2 | Polyol | D-sorbitol (60%, purified water 40%) | Sorbitol F | B Food Science Co., Ltd. |
| Sal-1 | Organic acid salt | Sodium lactate (60 ± 1%, | Sealuck U-6 | Blendex Co., Ltd. |
| | | purified water 40%) | | |
| Sal-2 | Organic acid salt | Potassium lactate (60 ± 1%, | Sealuck MK | Blendex Co., Ltd. |
| | | purified water 40%) | | |
| Sal-3 | Organic acid salt | Sodium pyrrolidone carboxylate | AJIDEW | Ajinomoto Healthy |
| | | (50%, purified water 50%) | | Supply Co., Inc. |
| BFFL | Oil and/or fat | Tallow hardened oil extremely hard flake | Tallow hardened oil | ADEKA CORPORATION |
| | | | extremely hard flake | |
| BFOL | Oil and/or fat | Beef oil | Beef oil S | Tsukasa Food Industry Ltd. |
| Z-1 | Food raw material | Mixture of 68.4 mass % of base*⁾ (26.2 mass | — | — |
| | (curry- based | % of crystalline product/73.8 mass % | | |
| | powder soup) | of powder raw material) and 31.6 mass % of | | |
| | | excipient (mixture of lactose and starch) | | |
| A-1 | Food raw material | Mixture of 68.4 mass % of base*⁾ (27.3 mass | — | — |
| | (curry- based | % of crystalline product/72.7 mass % | | |
| | powder soup) | of powder raw material) and 31.6 mass % of | | |
| | | excipient (mixture of lactose and starch) | | |
| B-1 | Food raw material | Mixture of 75.6 mass % of base*⁾ (30.6 mass | — | — |
| | (curry- based | % of crystalline product/69.4 mass % | | |
| | powder soup) | of powder raw material) and 24.4 mass % of | | |
| | | excipient (mixture of lactose and starch) | | |
| C-1 | Food raw material | Mixture of 80.4 mass % of base*⁾ (31.6 mass | — | — |
| | (curry- based | % of crystalline product/68.4 mass % | | |
| | powder soup) | of powder raw material) and 19.6 mass % of | | |
| | | excipient (mixture of lactose and starch) | | |

*Components of crystalline product: salt, granulated sugar, sodium glutamate, sodium inosinate, disodium succinate, glucose, ribonucleotide disodium, and the like
Components of powder raw material: chicken extract, pork extract, soy sauce, garlic extract, ginger extract, fermented extract, and the like

The composition of fatty acid ester Ap-1 was analyzed using gel permeation chromatography (GPC) and gas chromatography (GC).

The GPC measurement was performed using a gel permeation chromatograph analyzer (DGU-20A3/LC20AD/CBM-20A/SIL-20AHT/CTO-20AC/SPD-M20A/RID-10A/FRC-10A, available from Shimadzu Corporation). The conditions were as follows:
Column: Shim-pack GPC-80M (length 300 mm×inner diameter 80 mm)
Detector: Differential refractive index detector (RID)
Column temperature: 40° C.
Mobile phase: Tetrohydrofuran (THF)
Flow rate: 1 mL/min
Standard substance: Shodex STANDARD (Type: SM-105, available from Showa Denko K.K.)
Sample: Tetrahydrofuran (THF) solution, fatty acid ester concentration: 1 g/L, filtration through membrane filter (made of PTFE, 0.5 μm)
Injection volume: 20 μL

The GC measurement was performed using a gas chromatograph Agilent 7890B GC system (available from Agilent Technologies, Inc.). The conditions were as follows:
Column: DB-23 (available from Agilent Technologies, Inc., φ 0.25 mm×30 m, film thickness: 0.25 μm)
Detector: Hydrogen flame ionization detector (FID)
Inlet temperature: 250° C.
Detector temperature: 250° C.
Column temperature: 50° C. (held for 1 minute)→temperature rise: 10° C./min→170° C.→temperature rise: 1.2° C./min→210° C.
Sample introduction system: Split (1:20)
Hydrogen gas flow rate: 35 mL/min
Air flow rate: 300 mL/min
Nitrogen flow rate (makeup): 20 mL/min
Helium gas (carrier gas) pressure: 115 kPa
Injection volume: 1 μL
Collection amount: from 0.03615 to 0.04237 g
Final volume: 3 mL

In regard to the fatty acid ester Ap-1, peaks were observed in the GPC at a position where the weight average molecular weight (Mw) was from 2719 to 3271 (10.782 minutes) and from 826 to 878 (11.237 minutes). In the GC, it was confirmed that the composition of fatty acid was C18:C22=56:38. Based on these information, the molecular weights of glycerol or a polymer thereof and fatty acid were used to determine that the fatty acid ester Ap-1 was a mixture of monoglycerin behenate (molecular weight 755.25=92.09+340.58×2−18) and octaglycerin stearate (molecular weight 3008.72=610.58+284.48×9−18×9).

### <Evaluation Methods>

The characteristics of granular soup were evaluated using the following methods.

### <<Compressibility>>

The compressibility of a granular soup was measured at room temperature (23° C.) using a powder characteristic evaluation apparatus (Powder Tester (registered trademark) PT-X, available from Hosokawa Micron Group). A screen opening size was 1700 μm. An outlet of a funnel (outlet inner diameter: 7 mm) was corresponded to a height of 38 cm from an upper surface of a cylindrical container having an inner diameter of 40 mm, a height of 80 mm, and a volume of 100 cm³, and the mass of the granular soup filled in the cylindrical container when about 120 cm³ of the granular soup was put in the funnel and dropped was defined as the loose bulk density a (g/100 cm³). A cap for replenishing was attached to the same cylindrical container, the granular soup was dropped in the same procedure as in the measurement of the loose bulk density a, the granular soup was densified by tapping 10 times, then the cap was removed, thereafter the excess granular soup protruding from the upper surface of the cylindrical container was scraped, and the mass of the granular soup filled in the cylindrical container at that time was defined as the solid bulk density b (g/100 cm³). The compressibility was obtained by the formula: (b−a)×100/b.

### <<Angle of Repose, Angle of Disintegration, and Angle of Difference>>

The angle of repose and the angle of disintegration of a granular soup were measured at room temperature (23° C.) using a powder characteristic evaluation apparatus (Powder Tester (registered trademark) PT-X, available from Hosokawa Micron Group). A screen opening size was 1700 μm. The granular soup was dropped on a disk having a diameter of 8 cm through a funnel having an outlet height of 12 cm and an outlet inner diameter of 7 mm. The angle of the skirt of the mountain formed by the granular soup was defined as the angle of repose, and the angle of the skirt after the impact was applied to the mountain three times was defined as the angle of disintegration. A value obtained by subtracting the angle of disintegration from the angle of repose was defined as the angle of difference. Tapping was performed at a stroke length of 18 mm and a tapping speed of 60 times/min under standard conditions. The angle of difference is the difference between the angle of repose and the angle of disintegration (angle of repose−angle of disintegration).

### <<Carr Index>>

The information (loose bulk density, solid bulk density, compressibility, angle of repose, angle of disintegration, and angle of difference) obtained from a powder characteristic evaluation apparatus (Powder Tester (registered trademark) PT-X, available from Hosokawa Micron Group) can be indexed with reference to the fluidity index table and the floodability index table (see also Tohei YOKOYAMA et al., “Experimental Production of Apparatus for Measuring fluidity of Powders by Carr's Method”, Journal of the Society of Powder Technology, Japan, Vol. 6, No. 4 (1969), pp. 264 to 291). The sum obtained by adding the fluidity index to these indices is the Carr index (compressibility index+angle of repose index+fluidity index+angle of disintegration index+angle of difference index). The Carr index of the granular soup was calculated using MT1001k analysis software Ver 1.02 (available from SEISHIN ENTERPRISE Co., Ltd.).

### <<Evaluation Based on Carr Index>>

For the granular soup after the cup filling, a correlation between the number of cups with the filling amount outside the reference value and the Carr index was evaluated. Specifically, 100 cups filled with granular soup using a stroke feeder (speed: 29 shots/min) were each weighed, and then the number of cups deviating from a reference value (median+1 g) was compared with the Carr index. As evaluation criteria, “Excellent” indicates that there are 5 or less cups outside the reference value (Carr index: 75 or greater), “Good” indicates that there are from 6 to 10 cups outside the reference value (Carr index: 70 or greater and less than 75), “Acceptable” indicates that there are from 11 to 20 cups outside the reference value (Carr index: 65 or greater and less than 70), and “Unacceptable” indicates that there are 21 or more cups outside the reference value (Carr index: less than 65).

### Comparative Example 1

7 parts by mass of water was mixed with 100 parts by mass of a mixture of 94.0 parts by mass of Z-1 as (D) the food raw material and 6.0 parts by mass of tallow hardened oil extremely hard flakes BFFL as (C) the oil and/or fat, and the obtained mixture was extruded into granules from a perforated frame and dried at 100° C. for 10 minutes to prepare a granular soup. The granular soup did not contain (A) the fatty acid ester and (B) the organic acid salt.

### Examples 1 to 3

A granular soup was prepared by the following procedure.

### <<Preparation of First Mixture>>

A crystalline product in (D) the food raw material was pulverized into powder. Thereafter, (A) the fatty acid ester was mixed into (D) the food raw material using a conical blender in the formulation shown in Table 2 to prepare a first mixture. In Examples 1 to 3, PMX1-1 or PMX1-3 was used. Other first mixtures were used in the examples described below.

TABLE 2

| | |
|---|---|
| (D) Food raw | (A) Fatty acid ester |

| First mixture | material | Type | mass % |
|---|---|---|---|
| PMX1-1 | A-1 | Ap-1 | 0.78 |
| PMX1-2 | B-1 | Ap-1 | 0.88 |
| PMX1-3 | C-1 | Ap-1 | 0.92 |
| PMX1-4 | C-1 | Ap-1 | 0.87 |
| PMX1-5 | C-1 | Ap-1 | 0.82 |
| PMX1-6 | C-1 | Ap-1 | 0.79 |

### <<Preparation of Second Mixture>>

To 40 g of (C) the oil and/or fat put in a 3 L glass beaker (available from AGC Techno Glass Co., Ltd.) having an inner diameter of 165 mm, (B) the organic acid salt or another component corresponding to 5 g in terms of solid content was added, and the resulting mixture was stirred using a tornado stirrer (product name: TORNADO, turbine type P-65 type, stirring shaft: 50 cm, available from AS ONE Corporation.) to prepare an organic acid salt dispersion oil and another dispersion oil (hereinafter also simply referred to as “dispersion oil” in the Examples). The compositions thereof are shown in Table 3.

TABLE 3

| Dispersion oil | (B) Organic acid salt | (C) Oil and/or fat |
|---|---|---|
| DISP-1 | Sal-1 | BFOL |
| DISP-2 | Sal-2 | BFOL |
| DISP-3 | Sal-3 | BFOL |

The dispersion oil was put into a container provided with a hole having a diameter of from 1.0 to 4.0 mm, and the first mixture put into a stirring tank of a pin-type mixer was stirred for 10 minutes at a rotation speed of 70 rpm while the dispersion oil was added dropwise to the first mixture. After a lapse of 5 minutes from the completion of stirring, the mixture was taken out of the stirring tank, subjected to a vibration sieve of from 8 to 10 mesh (opening size: from 1.0 to 2.25 mm), and allowed to stand, thereby preparing a second mixture. The second mixture can be used as a powdery soup.

### <<Fluidized Bed Granulation>>

600 g of the second mixture was put into a plate of a fluidized bed coating device (flow coater, available from OKAWARA MFG. CO., LTD.), and floated with an intake air temperature set to from 80 to 95° C., a damper opening set to from 0.2 to 0.4 MPa, and a spray air pressure set to 0.18 MPa, and a 0.3 mass % aqueous solution of a thickener (guar gum, Orno SY-1, available from ORGANO FOOD TECH CORPORATION) was sprayed from a nozzle from a time point when an exhaust temperature reached 35° C. to form a granulated product. During fluidized bed granulation, the intake air temperature was finely adjusted so that the exhaust temperature was maintained at from 40 to 45° C. For spraying a thickener aqueous solution, a scale of a rotary pump was set to 4.5, and a spray amount was set to 70 mL. After 70 mL of the thickener aqueous solution was sprayed for about 10 minutes, drying was performed for 3 minutes, the intake air temperature was lowered to 45° C., cooling was performed, and then the granulated product was collected. Thereafter, the granulated product having a large particle size was removed using a sieve (TESTING SIEVE (opening size: 2 mm, wire diameter: 0.9 mm) available from Tokyo Screen Co., Ltd.) to prepare a granular soup. Table 4 shows the composition and physical properties of the granular soup.

TABLE 4

| | | | | Composition | | | | |
|---|---|---|---|---|---|---|---|---|
| | | | | | (A) Fatty | | (B) Organic | |
| | Second | First | Dispersion | (D) Food raw | acid ester | | acid salt | |
| | mixture | mixture | oil | material | Type | mass % | Type | mass % |
| Comparative | — | — | — | Z-1 | — | — | — | — |
| Example 1 | | | | | | | | |
| Example 1 | PMX2-1 | PMX1-1 | DISP-1 | A-1 | Ap-1 | 0.78 | Sal-1 | 0.49 |
| Example 2 | PMX2-2 | PMX1-1 | DISP-2 | A-1 | Ap-1 | 0.78 | Sal-2 | 0.49 |
| Example 3 | PMX2-3 | PMX1-3 | DISP-3 | C-1 | Ap-1 | 0.92 | Sal-3 | 0.57 |

| | Composition | | Physical properties | | | | |
|---|---|---|---|---|---|---|---|
| | (C) Oil and/ | | | Angle of | Angle of | | |
| | or fat | | Compressibility | repose | disintegration | | |
| | Type | mass % | [%] | [degree] | [degree] | Carr index | |
| Comparative | BFFL | 6.0 | 13.6 | 38.0 | 29.1 | 81.5 | Excellent |
| Example 1 | | | | | | | |
| Example 1 | BFOL | 3.9 | 14.4 | 37.2 | 29.1 | 80.0 | Excellent |
| Example 2 | BFOL | 3.9 | 14.7 | 40.2 | 30.4 | 79.5 | Excellent |
| Example 3 | BFOL | 4.6 | 11.3 | 38.4 | 28.7 | 84.0 | Excellent |

Changes in appearance and flavor when the granular soups of Example 1 and Comparative Example 1 were stored at normal temperature were examined. 20 g of granular soup, 60 g of noodles, and 5.5 g of ingredients (3.0 g of freeze-dried minced meat, 1.5 g of microwave dried fried chopped tofu M, 0.6 g of air-dried green onion, and 0.4 g of air-dried carrot flakes) were put in a paper cup, and the lid was sealed. The granular soup was allowed to stand at room temperature or in a refrigerator at 4° C., and the appearance and the flavor were confirmed every month.

The granular soup of Comparative Example 1 stored at normal temperature was aggregated so as not to move unless an impact was applied after a lapse of 3 months, and solidified after a lapse of 6 months. The granular soup of Example 1 stored at normal temperature had good fluidity even after a lapse of 8 months. On the other hand, in the case of the refrigerated storage, the granular soup of each of Comparative Example 1 and Example 1 retained good fluidity even after a lapse of 8 months.

Regarding the appearance and the flavor, there was no change in the granular soups of Comparative Example 1 and Example 1 in the normal temperature storage and the refrigerated storage.

### Examples 4 to 7

A granular soup was prepared by the following procedure.

A dispersion oil was prepared by the same procedure as in Example 1. The compositions thereof are shown in Table 5. The composition of DISP-2 is also listed again in Table 5. Parts by mass of the component of the dispersion oil in Table 5 are values based on 869 parts by mass of (D) the food raw material.

TABLE 5

| | (B) Organic acid salt/other component | | (C) Oil and/or fat | |
|---|---|---|---|---|
| Dispersion | | Part(s) | | Part(s) |
| oil | Type | by mass | Type | by mass |
| DISP-2 | Sal-2 | 5 | BFOL | 40 |
| DISP-4 | Pol-1/Sal-2 | 5/5 | BFOL | 80 |
| DISP-5 | Pol-1/Sal-1/Sal-2 | 5/5/5 | BFOL | 120 |
| DISP-6 | Pol-1/Pol-2/Sal-1/Sal-2 | 5/5/5/5 | BFOL | 160 |

The second mixture was obtained by the same procedure as in Example 1 using the resulting dispersion oil. Thereafter, the second mixture was granulated in a fluidized bed in the same procedure as in Example 1 to prepare a granular soup. In the fluidized bed granulation, the intake air temperature was 80° C., and an attained temperature in the fluidized bed was 60° C. Spraying of the thickener aqueous solution was performed by repeating a cycle of spraying for 2.5 minutes and intermediate drying for 20 seconds. After 70 mL of the thickener aqueous solution was sprayed for about 10 minutes, drying was performed for 3 minutes, the intake air temperature was lowered to 45° C., cooling was performed, and then the granulated product (granular soup) was collected. Table 6 shows the composition and physical properties of the granular soup.

TABLE 6

| | | | Composition | | | | |
|---|---|---|---|---|---|---|---|
| | Second mixture | | | (A) Fatty acid | | (B) Organic acid salt/ | |
| | First | Dispersion | (D) Food | ester | | other component | |
| | mixture | oil | raw material | Type | mass % | Type | mass % |
| Example 4 | PMX1-3 | DISP-2 | C-1 | Ap-1 | 0.92 | Sal-2 | 0.57 |
| Example 5 | PMX1-4 | DISP-4 | C-1 | Ap-1 | 0.87 | Pol-1/Sal-2 | 1.08 |
| Example 6 | PMX1-5 | DISP-5 | C-1 | Ap-1 | 0.82 | Pol-1/Sal-1/Sal-2 | 1.56 |
| Example 7 | PMX1-6 | DISP-6 | C-1 | Ap-1 | 0.79 | Pol-1/Pol-2/Sal-1/Sal-2 | 1.99 |

| | Composition | | Physical properties | | | | |
|---|---|---|---|---|---|---|---|
| | (C) Oil and/ | | | Angle of | Angle of | | |
| | or fat | | Compressibility | repose | disintegration | | |
| | Type | mass % | [%] | [degree] | [degree] | Carr index | |
| Example 4 | BFOL | 4.6 | 14.7 | 40.2 | 30.4 | 79.5 | Excellent |
| Example 5 | BFOL | 8.8 | 12.2 | 38.3 | 29.9 | 79.5 | Excellent |
| Example 6 | BFOL | 12.5 | 8.3 | 37.5 | 31.0 | 80.3 | Excellent |
| Example 7 | BFOL | 15.9 | 16.1 | 40.1 | 35.4 | 68.0 | Acceptable |

### Examples 8 to 9

A granular soup was prepared by the same procedure as in Example 1. Table 7 shows the composition and physical properties of the granular soup. The compositions and physical properties of Comparative Example 1 and Example 2 are also listed again in Table 7.

TABLE 7

| | | | Composition | | | | | |
|---|---|---|---|---|---|---|---|---|
| | | | (D) Food raw material | | | | (B) Organic | |
| | Second mixture | | | Excipient | | | acid salt/other | |
| | First | Dispersion | | content | (A) Fatty acid ester | | component | |
| | mixture | oil | Type | [mass %] | Type | mass % | Type | mass % |
| Comparative | — | — | Z-1 | 31.6 | — | — | — | — |
| Example 1 | | | | | | | | |
| Example 2 | PMX1-1 | DISP-2 | A-1 | 31.6 | Ap-1 | 0.78 | Sal-2 | 0.49 |
| Example 8 | PMX1-2 | DISP-2 | B-1 | 24.4 | Ap-1 | 0.88 | Sal-2 | 0.56 |
| Example 9 | PMX1-3 | DISP-2 | C-1 | 19.6 | Ap-1 | 0.92 | Sal-2 | 0.58 |

| | Composition | | Physical properties | | | | |
|---|---|---|---|---|---|---|---|
| | (C) Oil and/ | | | Angle of | Angle of | | |
| | or fat | | Compressibility | repose | disintegration | | |
| | Type | mass % | [%] | [degree] | [degree] | Carr index | |
| Comparative | BFFL | 6.0 | 13.6 | 38.0 | 29.1 | 81.5 | Excellent |
| Example 1 | | | | | | | |
| Example 2 | BFOL | 3.9 | 14.7 | 40.2 | 30.4 | 79.5 | Excellent |
| Example 8 | BFOL | 4.4 | 13.4 | 37.5 | 39.0 | 81.5 | Excellent |
| Example 9 | BFOL | 4.6 | 13.1 | 37.8 | 27.9 | 82.0 | Excellent |

1. A granular food comprising:
(A) at least one fatty acid ester selected from the group consisting of a (poly)glycerin fatty acid ester having an average polymerization degree of a glycerin moiety of from 1 to 8 and a sucrose fatty acid ester having an HLB of 8 or less;
(B) an organic acid salt;
(C) an oil and/or fat; and
(D) a food raw material,
wherein
the granular food contains from 3 mass % to 15 mass % of the oil and/or fat, and has a Carr index of 79 or greater.

2. The granular food according to claim 1, wherein the organic acid salt includes at least one selected from the group consisting of sodium lactate and potassium lactate.

3. A granular food comprising:
(A) at least one fatty acid ester selected from the group consisting of a (poly)glycerin fatty acid ester having an average polymerization degree of a glycerin moiety of from 1 to 8 and a sucrose fatty acid ester having an HLB of 8 or less;
(B) an organic acid salt;
(C) an oil and/or fat; and
(D) a food raw material,
wherein
the granular food contains greater than 15 mass % and 20 mass % or less of the oil and/or fat, and has a Carr index of 67 or greater.

4. The granular food according to claim 3, wherein the organic acid salt includes at least one selected from the group consisting of sodium lactate and potassium lactate.

5. A method for manufacturing a granular food, the method comprising:
preparing a first mixture of (A) at least one fatty acid ester selected from the group consisting of a (poly)glycerin fatty acid ester having an average polymerization degree of a glycerin moiety of from 1 to 8 and a sucrose fatty acid ester having an HLB of 8 or less and (D) a food raw material;
preparing a second mixture of an organic acid salt dispersion oil including (B) an organic acid salt and (C) an oil and/or fat and the first mixture; and
forming a granulated product of the second mixture by fluidized bed granulation.
